(19) United States
(12) Patent Application Publication
(10) Pub. No.: US 2008/0306825 A1
(43) Pub. Date: Dec. 11, 2008

(54) METHOD AND SYSTEM FOR MAKING AWARDS BASED ON THE TRAVELS OF AN ARTIFACT

(76) Inventors: Bradley M. Schick, Seattle, WA (US); Stephen Joseph Toutonghi, Seattle, WA (US)

Correspondence Address: HAHN AND MOODLEY, LLP, P.O. BOX 52050, MINNEAPOLIS, MN, 55402, US

(21) Appl. No.: 12/135,049

(22) Filed: Jun. 6, 2008

Related U.S. Application Data
(60) Provisional application No. 60/942,206, filed on Jun. 6, 2007.

(51) Int. Cl. G06Q 99/00; G06Q 30/00

(52) U.S. Cl. 705/14; 705/1

(57) ABSTRACT

In one aspect, the invention discloses an itinerant artifact in the form of a toy that embarks on travel to different places. Associated with the artifact may be a mission which includes at least one location/place that the artifact must travel to in order to be eligible for an award.

This application claims the benefit of priority to U.S. Provisional Patent Application 60/942,206, filed Jun. 6, 2007 and entitled “System and Method for Providing Rewards Based on Geo-Travel of a Device”, the entire specification of which is hereby incorporated by reference.

### FIELD

Embodiments of the present invention relate to a novelty toy, and a method and system for people to interact with each other.

### BACKGROUND

People crave social interaction with others who share common interests. This may explain the immense popularity of social networking services such as MySpace and Facebook which seek to build online social networks or communities where people with common interests may interact with each other.

Businesses seek new ways to promote their products and to create brand recognition.

### SUMMARY

In one aspect, the invention discloses an itinerant artifact in the form of a toy that embarks on travel to different places. Associated with the artifact may be a mission which includes at least one location/place that the artifact must travel to in order to generate awards. In some cases the artifact may be taken to each location in its mission by its owner. In other cases helpers other than the owner may do so.

In another aspect, the invention discloses techniques for the artifact to generate and report location data to a remote application.

In yet another aspect, a process for the remote application to make an award based on the location data is disclosed.

Other aspects of the invention will be apparent from the detailed description that follows.

### BRIEF DESCRIPTION OF THE DRAWINGS

FIG. 1 illustrates the various components required to generate awards from an itinerant artifact, in accordance with one embodiment of the invention.

FIG. 2 shows a high-level block diagram of hardware that may be used to realize an itinerant artifact, in accordance with one embodiment of the invention.

FIG. 3 shows a flowchart of a process for making an award to an itinerant artifact, in accordance with one embodiment.

FIG. 4 shows a high-level block diagram of hardware that may be used to realize a host or a server for implementing a method for making an award to an itinerant artifact, in accordance with one embodiment.

### DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Broadly, embodiments of the invention disclose technology for a service that enables exploring, collecting, and socializing. For descriptive convenience, the service will be referred to herein as “the Wegos service”. As will be described, the service may be used to give people new ways to do things they love to do—see new places, gather memories of places they've been, and meet new people along the way.

In one embodiment, through the service, a customizable virtual persona or online character is paired with an inexpensive itinerant artifact. In one embodiment, the itinerant artifact may be in the form of a Universal Serial Bus (USB) toy, called a “Wegos bod”. When a user plugs the USB toy into a computer, the toy sends information about its current location to a website (hereinafter “Wegos website”) running a remote application to implement the Wegos service.

Advantageously, in one embodiment as the ‘bod’ travels to different locations awards are made, as will be described. Awards may include rewards such as discounts, physical goods, cash, recognition, media, online virtual goods, etc. For example, the online character might get a ‘Cheesehead hat’ when the toy goes to Milwaukee, learn slide guitar if the toy goes to Nashville, or get a latte when the toy goes to Seattle.

In one embodiment as the ‘bod’ travels to different locations, the owner of the ‘bod’ receives rewards. For example, the owner may receive a discount coupon after the ‘bod’ has gone to ten Starbucks retail outlets.

In one embodiment, the toy's owner may purchase the toy. The owner then connects to the Wegos website and selects a predefined mission for the toy from a plurality of available predefined missions. A mission may be regarded as the locations the toy must travel to in order to claim rewards through the Wegos service. In other embodiments, the owner may define a custom mission for the toy using the Wegos service.

In some cases a toy may not have a mission at all. In such cases awards will be made based on the locations that the toy reaches. For example, an owner may leave a toy having no mission on a park bench in Seattle. If someone picks it up and carries to Tacoma, in some embodiments, an award can be made by the Wegos service once the toy reports its location as Tacoma to the Wegos service.

In some embodiments, the toy may be given to the owner as part of a promotion. For example a corporation such as the Coca-Cola Company may distribute a number of itinerant artifacts/toys to people freely. These artifacts may have a predefined mission designed to promote awareness of the company or a product of the company. As another example, the retailer with a number of physical locations may gainfully use the artifacts and the Wegos service of the present invention as follows. For example, the retailer, say Toys r Us may freely distribute itinerant artifacts with a mission to visit a specified number of store locations of the retailer. Awards may then be made when an artifact completes its mission.

A toy's owner (hereinafter “owner”) may take the toy to the various places required to complete its mission. Alternatively, the toy's owner may enlist the support of others (referred to herein as “helpers”) to assist the toy in completing its mission. For example, the toy's owner may mail the toy to a friend who would help it on its mission by either taking it to a place it has to travel to in terms of its mission, or by in turn mailing it to another person who would likewise assist in completing its mission. Thus, a chain of people may be involved in assisting a particular toy in achieving its mission. In other words, the entity that assists the toy in achieving its mission may be a single person or it may be a chain of people. In the latter case, the chain may be built ad hoc. Alternatively the chain may be predefined in the sense of having the people comprising the chain register as a team using the Wegos service. Thus, multiple teams may compete for rewards offered by the Wegos service. Advantageously, competitions may be set up with the Wegos service in terms of which competing itinerant artifacts may be required to complete a common mission, say in the shortest possible time, in order to claim a prize. In some cases, the prize may be sponsored by a corporation as part of a marketing exercise.

Awards may be made upon a condition or mission being completed or partially completed. Awards in form of rewards may be given to owners and/or helpers. In some cases the owners and helpers are rewarded directly as in the case of cash, discounts, or things being given to them. In other cases, the rewards may be indirect in the sense that the online virtual character paired with a toy being given additional skills, features, or things.

In some embodiments, custom missions may be as simple or as complex as the owner wishes—from, ‘go to 5 new cities,’ to ‘visit every MLB stadium,’ to ‘go around the world.’

Embodiments of the Wegos service may include providing a social networking website to enable other Wegos ‘bod’ owners, helpers, and others to interact with each other. In one embodiment, the website may provide information on various missions, a leader board for common missions, mini-games, etc.

In one embodiment, the online character may exist on the Wegos website and in a profile that may be embedded in other social networks, such as MySpace and Facebook. The profile may link back to the Wegos website. As the toy travels, the character gets new and potentially rare collectible items, new animations, a growing map of its travels, and notes and photos left by people who have helped it. All of this can be shown off by the owner through the Wegos website or a profile embedded on other social networks.

In one embodiment, the Wegos service will provide online rewards based on the real-world travels of an itinerant artifact. The service may offer rewards for bringing the device to locations such as the stores of retail partners.

In one embodiment, self-service ‘Wegos Stations’ may be provided at public locations such as retail locations. Each Wegos station may have a USB interface, in one embodiment, whereby a Wegos ‘bod’ may connect to a Wegos website after plugging into the station so that the ‘bod’ is recognized as having visited the location associated with the Wegos station. The Wegos stations may be used to enable co-promotions with brick and mortar chains (e.g., visit McDonalds to get a Ronald McDonald wig for your online character).

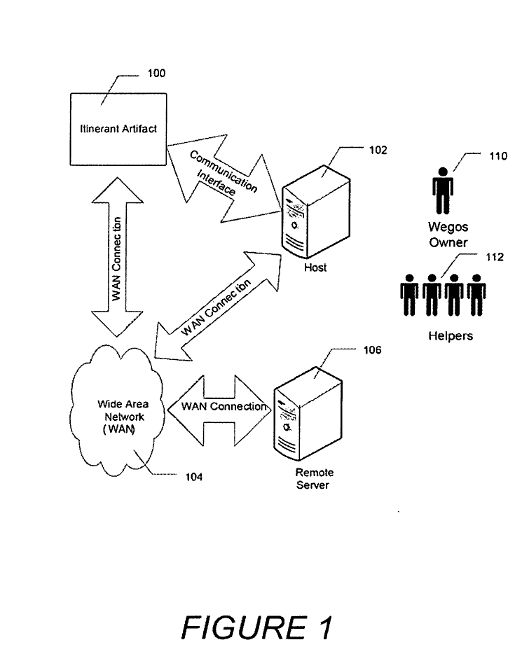

FIG. 1 of the drawings illustrates the various components required to implement the techniques described above, in accordance with one embodiment. The components shown in FIG. 1 will now be described:

Itinerant artifact (100). As described above, this is a device that is capable of gathering and reporting location relevant data. Examples of location relevant data include data that either describes a geographic location or from which a geographic location may be deduced, such as GPS, Radio Frequencies, Radio Data System (RDS)/Radio Broadcast Data System (RBDS), data identifying proximal cellular towers or Wi-Fi hotspots, storing close range signals broadcast through technology such as BlueTooth by other devices, etc. In practice a number of artifacts would be circulating with the general public at any given time. Each artifact includes an external communication interface used to send data through a host 102 or via a WAN 104 to a remote server 106. In some embodiments, an artifact may include a battery. An embodiment, containing a battery may include the ability to broadcast a unique identification, for example, through BlueTooth, and the ability to receive, store and/or transmit unique identification for other devices in such a way as to derive location information that may be used to satisfy award criteria.

Wegos Owner (110). This is the entity (person or group) whose user account the remote server (106) considers to be the owner of an itinerant artifact. The user account and its relations to one or more itinerant artifacts may be provisioned and managed by the remote server (106).

Helpers (112). These are the individuals or groups who help an itinerant device travel and/or help report its movements to the remote server 106. Helpers may or may not have user accounts managed by the remote server 106.

Host (102). A host is a computing device that can communicate with and/or detect the nearby presence of an artifact 100. In some embodiments, the location of a host 102 is known and may be used to infer the location of an artifact 100 that connects to the host 102 given that such a connection would only be possible of the artifact was in close proximity to the host 102. According to different embodiments, a host 102 may comprise computing devices such as a desktop, laptop, notebook or similar computer, a server, public kiosk/terminal (Wegos Station), a point of sale device, a mobile phone, PDA or similar computer, etc. A host 102 may be connected to a WAN 104 to establish a connection to a remote server 106 in order to report data gathered from an artifact 100.

Wide Area Network (Wan) (104). This includes any of several possible computer networks covering a broad geographic area. Examples include, but are not limited to, private cellular networks, the public Internet, leased data lines, etc.

Remote server (106). This is a device or virtual device that is connected to a WAN 104 and runs the Wegos service The server 106 characteristically has an address defined through a communications or network protocol through which it can be located on a WAN 104. The remote server 106 runs one or more software application(s) that provide Wegos services based at least in part on location relevant data received from artifacts 100. The location data is used to provide services to the owners 110 and the helpers 112. One such service includes a rewards system based on the geographic travels of an artifact, as described.

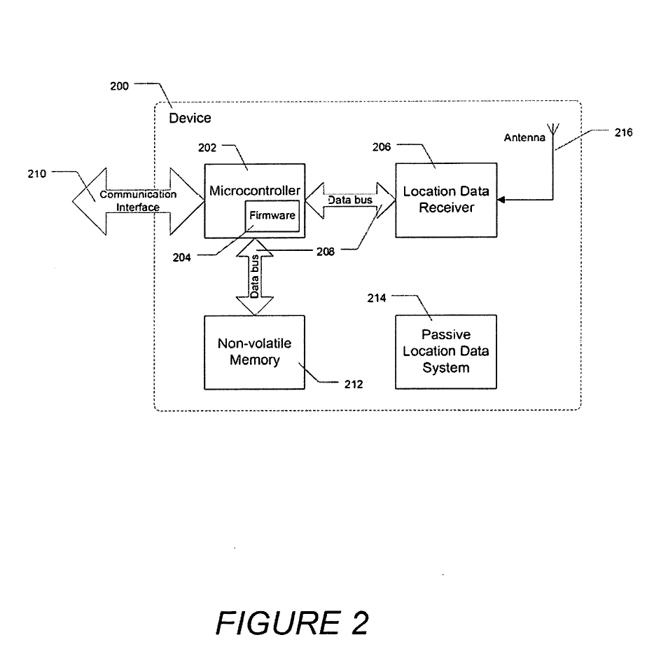

FIG. 2 of the drawings shows a high level block diagram of hardware 200 that may be used to implement an artifact 100, in accordance with one embodiment of the invention. The components of the hardware 200 will now be described:

Microcontroller (202). The microcontroller 202 executes instructions within firmware 204, enabling functions of the communication interface and the transfer of data from one or more location data receivers 206 to and from other devices and/or systems.

Firmware (204). The firmware 204 contains instructions that drive the operations of the artifact hardware 200. In one embodiment, the firmware 204 instructs the microcontroller 202 to send and receive data over an internal data bus 208, performs mathematical and logical operation on the data, and sends and receives data over an external communication interface 210.

Location Data Receiver (206). The location data receiver 206 gathers available location relevant data. The receiver 206 may gather data from one or more of any of various available signal sources including GPS, Radio Data System (RDS) or Radio Broadcast Data System (RBDS), cellular communications, Wi-Fi hotspots, BlueTooth device identification, etc.

Non-volatile Memory (212). The non-volatile memory 212 stores data as needed to complete operations performed by the microcontroller 202 and firmware 204. The device may use the non-volatile memory 212 to store location data for future transmission over the external communication interface 210.

Communication Interface (210). The communication interface 210 allows for connectivity with other devices and/or systems. The interface 210 may comprise one or more interfaces such as USB, Bluetooth, Ethernet, Serial, Wi-Fi, GSM, etc. In some embodiments, implementation of a passive location data system 214 such as RFID may provide a communication interface that allows reception of an artifact's unique identification by a host 102.

Antenna (216). An antenna may be included in some embodiments of the artifact to increase the effective sensitivity of the Location Data Receiver.

Passive Location Data System (214). In some embodiments, the hardware 200 may include one or more passive location data systems that may provide data to another system that will determine the location of the artifact embodied by the hardware 200. For example, an RFID tag, or similar device, may be included in the hardware 200 to allow an external system to detect the presence of the hardware 200.

Data Bus (208). The data bus 208 allows for movement of data between internal components of the device

An exemplary process flow performed by the hardware 200, in accordance with one embodiment will now be described:

When the hardware 200 receives power or is restarted, the firmware 204 directs the microcontroller 202 to send instructions over the data bus 208 that cause the location data receiver 206 to begin gathering location data. The firmware waits for a signal sent by the location data receiver 206 over the data bus 208 indicating that it has gathered relevant data. The firmware 204 then instructs the microcontroller 202 to read the gathered data from the location data receiver 206 over the data bus 208. These steps are repeated until the location data receiver 206 signals that no more data can be gathered.

The firmware 204 may then process the gathered data using well known mathematical and logical algorithms to convert the data into other formats that can be later sent over the external communication interface 210. In one embodiment, the firmware 204 also encrypts the data so that it may not be observed or modified without detection, except by the remote server 106.

The firmware 204 then instructs the microcontroller 202 to send the encrypted location data to the non-volatile memory 212 over the data bus 208. The data is preserved on the non-volatile memory 212 until it can be sent over the external communication interface 210.

The external communication interface 210 may take one or more forms. In some embodiments, the hardware 200 includes a Universal Serial Bus (USB) connector along with associated hardware and software interfaces, modules, processes, etc. In these embodiments, the connection with a host 102 may be accomplished through the USB interface when the USB connector is plugged into the a USB port of a host 102. In some embodiments, the hardware 200 includes the requisite software and hardware to establish a connection directly to a WAN 104, such as by using one or more of several wireless technologies (e.g., cellular GSM networks, 802.11, BlueTooth, etc), or a physical connector (Ethernet, serial port, etc.).

When the external communication interface 210 becomes active, the firmware 204 instructs the microcontroller 202 to read the encrypted location data from the non-volatile memory 212 over the data bus 208. The firmware 204 then instructs the microcontroller 202 to send the encrypted location data along with the unique identifier associated with an individual artifact 100 through the communication interface 210. Depending on the nature of the communication interface 210, the data may be transmitted either over a WAN 104 or through a host 102 to the remote server 106. These steps are repeated until all location data stored on the non-volatile memory 212 have been sent to the application 106.

When the external communication interface 210 is connected to a host 102 in a known location, the host 102 may also write location data to the artifact 100. The firmware 204 encrypts and stores this location data to the non-volatile memory 212 just as it stores the location data gathered by the location data receiver 206. The location data originating from the host 102 can later be sent to the remote server 106 through any means supported by the artifact 100.

An exemplary process flow performed by a host 102, in accordance with one embodiment, will now be described:

As described above, a host 102 is a computing device that can communicate with and optionally detect the nearby presence of an artifact 100. The geographic location of a host 102 may or may not be known.

In accordance with one embodiment, an artifact 100 is connected to a host 102 that is in an unknown geographic location. The host 102 connects to the artifact through the communication interface 210, and gathers all of the encrypted location data along with the unique identifier for that artifact 100, as described above. The gathered data is then sent over a WAN 104 to the remote server 106.

In accordance with a second embodiment, an artifact 100 is connected to a host 102 that is in a known geographic location. The host 102 may gather location data from the artifact 100 and sends it over a WAN 104 to the remote server 106, in the manner described above. Because the host 102 is in a known location it may add its own location data to the data sent to the remote server 106. Alternatively the host 102, may write its location data to the artifact 100. This may be done when the host 102 itself has no connection to a WAN 104. The location data is stored on the artifact's non-volatile memory 212. The location data may later be sent through a WAN 104 or a WAN-connected host 102 to the remote server 106, using the techniques described above.

In cases where an artifact 100 contains a passive location data system 214, such as RFID, a host 102 may detect the presence of an artifact 100 through its passive location data system 214. In this case the artifact's location will be taken to be the location of the host 102, which will be known a priori. The host 102 will then encrypt and send its location along with the unique identifier for an artifact 100 to the remote server 106 through a WAN 104.

In some embodiments, the connection between a host 102 and the remote server 106 may be initiated by the user opening a document, such as an HTML document, that includes a network address (e.g. in the form of a Uniform Resource Identifier (URI)) of the remote server 106. In some embodiments, establishing a connection between an artifact 100 and a host 102 starts a process on the host 102 that establishes a connection to the remote server 106, with or without user involvement. In some embodiments, the connection is initiated by a software application or module or service running on the host 102 that has gathered passive location data, such as RFID data, from one or more artifacts.

To connect to the remote server 106, the host 102 requires the network address of the remote server 106. It will be appreciated that there are a variety of methods for providing a computer with a specific address on a WAN. In various embodiments the host 102 connects to the remote server 106 using an address supplied by an artifact 100. In some such embodiments, for example, the address might be a URI or similar such address stored on the artifact 100 and made available when the artifact 100 connects to a host 102. In some embodiments, an application is installed on the host 102 that includes the network address for the remote server 106

An exemplary process flow performed by a remote server 106, in accordance with one embodiment, will now be described:

The remote server 106 receives encrypted data from each artifact 100 in circulation, in accordance with the processes described above. The data include location relevant data along with a unique identifier for the artifact 100. The received data is in an encrypted form that is only readable by the remote server 106.

The data is decrypted and processed by the remote server 106 and associated with the artifact 100 identified by the unique identifier. In some embodiments, the location relevant data, such as that gathered by an artifact 100 with a GPS-based location data receiver 206, may include information that may directly describe the geographic location of a the artifact 100. In other embodiments, the location relevant data, such as that gathered by an artifact 100 with an FM radio RDS based location data receiver 206, may require the remote server 106 to deduce the actual geographic location of the artifact based on proximity to signal sources known to the remote server 106.

Whenever a geographic location is determined for an artifact 100, the remote server 106 stores that location in a travel log for the artifact 100 in a non-volatile memory location, such as a disk drive. The cumulative stored location data is used to provide services to the owner 110 and the helpers 112 associated with the artifact 100. Among others, the remote server 106 may provide the following services:
User Account Setup and Maintenance. Accounts used to authenticate owners 110 and helpers 112 and authorize them to access other services.
Location tracking. The remote server 106 displays a travel log for each artifact. The travel log comprises a history of the locations the artifact 100 has traveled to. The travel log may be provided in a manner relevant to other remote application services.
Establishing conditions/criteria for rewards. The remote server 106 provides the ability to define at least one condition that must be satisfied before an entity (i.e. any combination of owner and helpers associated with a particular artifact 100) is given an award. A condition may be specified as a location that the artifact 100 must travel to. Several conditions may be specified and may together define a mission for an artifact 100. Awards may take the form of rewards, as described above.
Making Awards. Determining whether conditions have been met before making awards. As noted above awards may include rewards which may take a variety of forms including online virtual goods, recognition, cash prizes, physical merchandise, discounts, media, etc.
Providing context that lends meaning to rewards. In some embodiments, some rewards may have value based on context provided by the remote server 106. An example would be if the remote server included a virtual persona or animated online character associated with an artifact 100, and a reward was an item of clothing or a possession that could be added to the animation. In a similar fashion, other examples would be graphics or sounds whose value derives from their placement in the context of one or more service(s) provided by the remote server.
Setup and Maintenance of Profiles for Owners and Helpers. In one embodiment, a profile will display all artifacts 100 belonging to a particular owner 110 along with a graphical representation of each of artifact's travels and rewards. Among other uses, this profile may be embedded within other online applications.

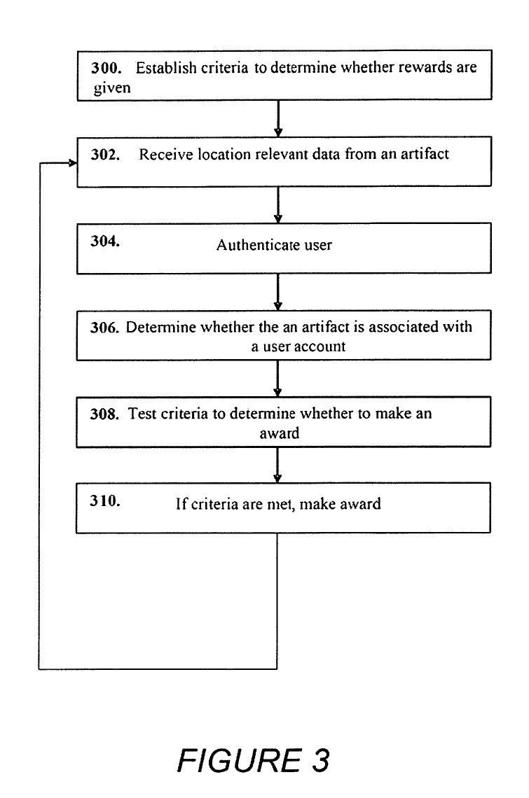

FIG. 3 shows a flowchart of specific operations performed by the remote server 106 to offer awards, in accordance with one embodiment. The processing blocks in the flowchart will now be described:

300. Establish criteria/conditions for making an award. In various embodiments, an award in the form of a reward is given to an owner of an artifact 100 and/or the helpers associated with assisting the artifact 100 in satisfying a condition. As described above, a condition may be defined as a geographic location that the artifact 100 has to travel to before an award can be made. Several conditions may be defined to form a mission for the artifact 100. The conditions may be user-defined or they may be predefined.

302. Receive location relevant data from an artifact. The remote server 106 receives location relevant data from each artifact 100, in the manner described above.

304. Authenticate user. In some embodiments and for some award criteria, it is necessary or desirable to authenticate the user in possession of an artifact 100 at the time that its location is reported to the remote server 106. In some embodiments, user authentication is initiated when the user provides the username and password associated with his account, for example, via a web page. If the user does not yet have a user account, the user is given an opportunity to create a user account and thereby be authenticated by the remote server 106. In one embodiment, if the authenticated user is not the owner associated with the artifact 100, that person is considered a helper unless the artifact 100 is not yet associated with an owner account.

306. Determine whether an artifact is associated with an owner account. The data sent to the remote server 106 contains the unique identifier (ID) of the reporting artifact. The remote server 106 determines whether the artifact 100 associated with the unique ID is already associated with a user account. In one embodiment, if such an association exists, the user account is considered to be the artifact owner's account. If there is no such owner's account, the remote server 106 begins a process to associate the artifact's unique ID with a user account. In some embodiments this process includes asking the user whether he/she wishes to associate the artifact with their account. In other embodiments this process may be automatic.

308. Test criteria to determine whether to make an award. The remote server 106 tests criteria established in 300 against conditions including the reported or derived location of the artifact, as described in 302.

310. If criteria are met, make award. If criteria established in 300 are met, give appropriate reward(s) to the artifact owner 110 and/or the artifact helper(s) 112.

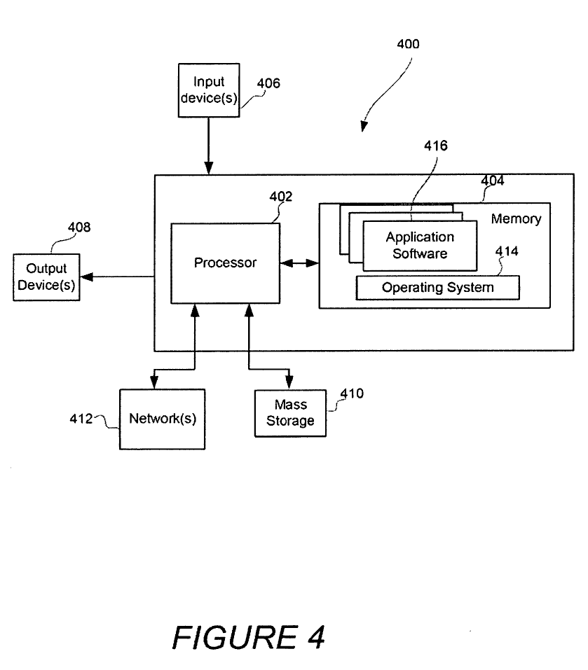

FIG. 4 of the drawings shows a block diagram of hardware 400 that may be used to implement the host 102 and the remote server 106, in one embodiment. Referring to FIG. 4, the hardware 400 includes at least one processor 402 coupled to a to memory 404. The processor 402 may represent one or more processors (e.g., microprocessors), and the memory 404 may represent random access memory (RAM) devices comprising a main storage of the hardware 400, as well as any supplemental levels of memory e.g., cache memories, non-volatile or back-up memories (e.g. programmable or flash memories), read-only memories, etc. In is addition, the memory 404 may be considered to include memory storage physically located elsewhere in the hardware 400, e.g. any cache memory in the processor 402, as well as any storage capacity used as a virtual memory, e.g., as stored on a mass storage device 410.

The hardware 400 also typically receives a number of inputs and outputs for communicating information externally. For interface with a user or operator, the hardware 400 may include one or more user input devices 406 (e.g., a keyboard, a mouse, a scanner etc.) and a display 408 (e.g., a Liquid Crystal Display (LCD) panel). For additional storage, the hardware 400 may also include one or more mass storage devices 410, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 400 may include an interface with one or more networks 412 (e.g., a local area network (LAN), a wide area network (WAN), a wireless network, and/or the Internet among others) to permit the communication of information with other computers coupled to the networks. It should be appreciated that the hardware 400 typically includes suitable analog and/or digital interfaces between the processor 402 and each of the components 404, 406, 408 and 412 as is well known in the art.

The hardware 400 operates under the control of an operating system 414, and executes various computer software applications, components, programs, objects, modules, etc. indicated collectively by reference numeral 416 to perform the techniques described above

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

1. A method, comprising:
establishing at least one condition for making an award, wherein the at least one condition comprises a requirement that a itinerant artifact has been to a particular location; and
making an award based on the locations said artifact has traveled to.

2. The method of claim 1, wherein said establishing comprises establishing a plurality of said conditions which together define a mission for the itinerant artifact.

3. The method of claim 2, wherein making the award comprises rewarding an entity associated with the itinerant artifact.

4. The method of claim 2, wherein a reward is selected from the group consisting of discounts, cash, and physical gifts.

5. The method of claim 3, wherein the entity comprises at least one person who assisted the itinerant artifact in at least partially completing its mission.

6. The method of claim 1, further comprising creating a virtual persona for the itinerant artifact.

7. The method of claim 6, wherein making the award comprises changing the virtual persona based on the locations the artifact has traveled to.

8. The method of claim 7, wherein the changing comprises making changes selected from the group consisting of changes in abilities of the virtual persona, changes to an appearance of the virtual persona, and additions to possessions of the virtual persona.

9. The method of claim 1, further comprising distributing a plurality of the itinerant artifacts, each with a predefined mission, as part of a promotion.

10. The method of claim 2, wherein said establishing comprises providing an interface to allow input of the mission.

11. The method of claim 5, further comprising providing a mechanism to embed the virtual persona into a profile on a social networking site.

12. The method of claim 2, further comprising creating a competition wherein a number of itinerant artifacts compete with each other to complete a common mission.

13. The method of claim 11, further comprising providing a website that provides information on how the competing itinerant artifacts are faring.

14. The method of claim 12, wherein the information is presented in the form of a leader board.

15. The method of claim 2, wherein making the award comprises receiving location information from the itinerant artifact, verifying that the itinerant artifact has satisfied at least one condition in its mission; and rewarding a person responsible for assisting the itinerant artifact in satisfying the condition.

16. The method of 14, further comprising providing a terminal at a public place, the terminal having an interface to communicate with an itinerant artifact to receive location data there from; and a network connection to transmit that location data to a remote application for processing.

17. A system, comprising:
a processor; and
a memory coupled to the processor, the memory storing instructions which executed by the processor cause the system to perform a method comprising:
establishing at least one condition for making an award, wherein at least one condition comprises a requirement that an itinerant artifact has been to a particular location; and
making an award based on the locations said artifact has traveled to.

18. The system of claim 16, wherein said establishing comprises establishing a plurality of said conditions which together define a mission for the itinerant artifact.

19. The system of claim 16, wherein making the award comprises rewarding an entity associated with the itinerant artifact.

20. The system of claim 16, wherein the method further comprises generating a virtual persona for the itinerant artifact.

21. The system of claim 16, wherein making the award comprises changing the virtual persona based on the locations the artifact has traveled to.

22. The system of claim 16, wherein the changing comprises making changes selected from the group consisting of changes in abilities of the virtual persona, changes to an appearance of the virtual persona, additions to possessions of the virtual person.

23. The system of claim 17, wherein said establishing comprises providing an interface to allow input of the mission.

24. The system of claim 22, wherein the method further comprises providing a mechanism to embed the virtual persona into a profile on a social networking site.

25. The system of claim 17, wherein the method further comprises creating a competition wherein a number of itinerant artifacts compete with each other to complete a common mission.

26. The system of claim 24, wherein the method further comprises providing information on how the competing itinerant artifacts are faring.

27. The system of claim 22, wherein the information is presented in the form of a leader board.

28. The system of claim 17, wherein making the award comprises receiving location information from the itinerant artifact, verifying that the itinerant artifact has satisfied at least one condition in its mission; and rewarding a person responsible for assisting the itinerant artifact in satisfying the condition.
